(19) United States
(12) Patent Application Publication
(10) Pub. No.: US 2022/0004909 A1
(43) Pub. Date: Jan. 6, 2022

(54) METHOD AND SYSTEM FOR PREDICTING ROAD NETWORK CONGESTION PROPAGATION SITUATION BASED ON EPIDEMIC MODEL

(71) Applicant: Beihang University, Beijing (CN)

(72) Inventors: Daqing Li, Beijing (CN); Shiyan Liu, Beijing (CN)

(73) Assignee: Beihang University, Beijing (CN)

(21) Appl. No.: 17/348,008

(22) Filed: Jun. 15, 2021

(30) Foreign Application Priority Data
Jun. 15, 2020 (CN) 202010540611.0

(51) Int. Cl. G06N 7/00; G06N 5/02

(52) U.S. Cl. CPC G06N 7/005; G06N 5/022

(57) ABSTRACT

A method and system for predicting a road network congestion propagation situation based on an epidemic model is provided. The method includes: obtaining road network data at a current time point; classifying the road network data based on road section types to obtain a road section set of each road section type; predicting a road network congestion situation at each time point within a predetermined time period based on the road section set of each road section type and the epidemic model to obtain road network prediction data; obtaining road network congestion propagation evaluation indexes, comprising a propagation scale, propagation duration, and a propagation velocity; and analyzing the road network prediction data based on the road network congestion propagation evaluation indexes to obtain the road network congestion propagation situation at the current time point.

### CROSS REFERENCE TO RELATED APPLICATION

This patent application claims the benefit and priority of Chinese Patent Application No. 202010540611.0 filed on Jun. 15, 2020, the disclosure of which is incorporated by reference herein in its entirety as part of the present application.

### TECHNICAL FIELD

The present disclosure relates to the field of road network congestion analysis, and in particular, to a method and system for predicting a road network congestion propagation situation based on an epidemic model.

### BACKGROUND ART

A growing number of vehicles results in a serious imbalance between a traffic resource supply and a travel demand, and increasing road congestion. For example, more than 90% of road sections in a road network are saturated or over-saturated during morning and evening peak hours in Beijing; an average degree of a road network load has reached 70%, of which a trunk road system has exceeded 90%. It should be noted that congestion on a single road section will propagate to road networks along and around the road according to certain rules, causing large-scale road network congestion. As a result, problems such as an inefficient road network operation and traffic safety issues occur, and accordingly restricting economic development. The key to solve these problems is how to conduct a comprehensive and in-depth analysis of a road network congestion propagation situation. Therefore, it is essential to propose an appropriate and effective method for analyzing the road network congestion propagation situation.

Researches of conventional road network congestion analysis methods are mainly carried out at macro and micro levels. At the macro level, many scholars currently study traffic congestion based on a macroscopic fundamental diagram (MFD), and believe that congestion does not occur provided that the number of vehicles in a given area is controlled within a threshold. However, these methods have limitations in the following three aspects: first, congestion has become normal during an actual operation, and the traffic demand is rigid, making it difficult to control an overall demand in a short term; second, a system MFD relationship is unstable and has a strong fluctuation in a control process, making it difficult to support real-time decisions on a road network management; third, the MFD cannot reflect time-space propagation rules of the congestion, making it difficult to support traffic management and control decisions. At the micro level, scholars currently use a cellular automation traffic flow model to simulate a process of the traffic congestion on local roads and describe generation, propagation, and dissipation of the congestion. However, limitations of this method are excessive model parameters, a low generalization ability, and a lack of real-time data.

In summary, the existing road network congestion analysis methods mainly have the following problems. In a road network reliability evaluation, these methods ignore a congestion propagation mechanism, resulting in a rigid control process. In decision-making, these methods often ignore congestion propagation over space, focus only on microscopic and local control without considering an inter-regional correlation, and lack algorithms and capabilities for global optimization. In prediction, these methods often ignore the congestion propagation over time, which cannot perform a comprehensive prediction based on historical data and real-time data, and lack a dynamic evaluation and an intelligent update of plans. In study and judgment, these methods ignore the congestion propagation, resulting in being unable to understand indirect and implicit causal relationships between traffic events, and blind in study and judgment.

### SUMMARY

The objective of the present disclosure is to provide a method and system for predicting a road network congestion propagation situation based on an epidemic model, so as to improve a real-time performance for predicting the road network congestion propagation situation.

To implement the foregoing objective, the present disclosure provides the following solutions.

A method for predicting a road network congestion propagation situation based on an epidemic model includes:

obtaining road network data at a current time point;

classifying the road network data based on road section types to obtain a road section set of each road section type, where the road section types include a congested road section, an uncongested road section susceptible to congestion, and an uncongested road section insusceptible to congestion;

predicting a road network congestion situation at each time point within a predetermined time period based on the road section set of each road section type and the epidemic model to obtain road network prediction data, where the road network prediction data include a road section prediction set of each road section type at each time point;

obtaining road network congestion propagation evaluation indexes, including a propagation scale, propagation duration, and a propagation velocity; and

analyzing the road network prediction data based on the road network congestion propagation evaluation indexes to obtain the road network congestion propagation situation at the current time point.

In an embodiment, the classifying the road network data based on road section types to obtain the road section set of each road section type may include:

obtaining a relative velocity on each road section at the current time point, where the relative velocity on the road section is a ratio of a real velocity on the road section to a quantile velocity on the road section, and the quantile velocity is a velocity at a predetermined quantile after velocities on the road section within the predetermined time period are sorted by magnitude;

determining whether the relative velocity is less than a congestion threshold;

when the relative velocity is less than the congestion threshold, determining the road section corresponding to the relative velocity as the congested road section; or

when the relative velocity is greater than or equal to the congestion threshold, determining the road section corresponding to the relative velocity as the uncongested road section;

determining a congested road section proportion corresponding to each uncongested road section, where the congested road section proportion is a proportion of a number of congested road sections in all road sections connected to the uncongested road section;

determining whether the congested road section proportion is greater than a proportion threshold; and

when the congested road section proportion is greater than the proportion threshold, determining the uncongested road section corresponding to the congested road section proportion as the uncongested road section susceptible to congestion; or

when the congested road section proportion is less than or equal to the proportion threshold, determining the uncongested road section corresponding to the congested road section proportion as the uncongested road section insusceptible to congestion.

In an embodiment, before the predicting the road network congestion situation at each time point within the predetermined time period based on the road section set of each road section type and the epidemic model to obtain road network prediction data, the method may further include:

determining the epidemic model based on the road section set of each road section type, where the epidemic model includes a susceptible-infectious-susceptible (SIS) model, a susceptible-infectious-recovered (SIR) model, a susceptible-infectious-recovered-susceptible (SIRS) model, and a susceptible-exposed-infectious-recovered (SEIR) model;

obtaining road network training data, where the road network training data are a road section set of each road section type at each time point within the predetermined time period;

inputting the road network training data into the epidemic model to obtain the road network prediction data, where the road network prediction data are a road section prediction set of each road section type at each time point within the predetermined time period;

calculating a residual between the road network prediction data and the road network training data;

determining whether the residual is less than a residual threshold; and

when the residual is greater than or equal to the residual threshold, updating parameters of the epidemic model by using weighted least-squares to fit model parameters, and returning to the step of inputting the road network training data into the epidemic model to obtain the road network prediction data; or

when the residual is less than the residual threshold, finishing the training to obtain a trained epidemic model.

In an embodiment, the predicting the road network congestion situation at each time point within a predetermined time period based on the road section set of each road section type and the epidemic model to obtain road network prediction data may include:

obtaining a first probability, a second probability, and a third probability at each time point within the predetermined time period, where the first probability is a probability that the uncongested road section susceptible to congestion becomes the congested road section, the second probability is a probability that the congested road section recovers to the uncongested road section, and the third probability is a probability that the recovered uncongested road section becomes the uncongested road section susceptible to congestion; and

predicting the road network congestion situation at each time point by using formulas of

$$\frac{{dC}_{t}}{dt} = \frac{β {F}_{t} {C}_{t}}{N} - γ {C}_{t}$$

to obtain the road network prediction data; where Cₜ represents a scale

$$\frac{{dF}_{t}}{dt} = \frac{β {F}_{t} {C}_{t}}{N} + {ξR}_{t}$$

$$\frac{{dR}_{t}}{dt} = γ {C}_{t} - ξ {R}_{t}$$

of a set of congested road sections at a time point t, and

$$\frac{{dC}_{t}}{dt}$$

represents an amount of change in the scale Cₜ of the set of congested road sections at the time point t; Fₜ represents a scale of a set of uncongested road sections susceptible to congestion at the time point t, and

$$\frac{{dF}_{t}}{dt}$$

represents an amount of change in the scale Fₜ of the set of uncongested road sections susceptible to congestion at the time point t; Rₜ represents a scale of a set of uncongested road sections insusceptible to congestion at the time point t, and

$$\frac{{dR}_{t}}{dt}$$

represents an amount of change in the scale Rₜ of the set of uncongested road sections insusceptible to congestion at the time point t; and β represents the first probability, γ represents the second probability, and ξ represents the third probability.

In an embodiment, the analyzing the road network prediction data based on the road network congestion propagation evaluation indexes to obtain the road network congestion propagation situation at the current time point may include:

determining a scale of a set of congested road sections at each time point within the predetermined time period based on the road network prediction data;

determining a maximum scale of the set of congested road sections within the predetermined time period, where a larger maximum scale of the set of congested road sections indicates a stronger road network congestion propagation capability;

determining propagation inflection point duration based on the scale of the set of congested road sections at each time point within the predetermined time period, where the propagation inflection point duration is duration from the current time point to a time point corresponding to the maximum scale of the set of congested road sections;

determining propagation end duration based on the scale of the set of congested road sections at each time point within the predetermined time period, where the propagation end duration is duration from the current time point to a time point at which the scale of the set of congested road sections is zero; and

dividing the maximum scale of the set of congested road sections by the propagation inflection point duration to obtain a road network congestion propagation velocity.

A system for predicting a road network congestion propagation situation based on an epidemic model includes:

a road network data obtaining module, configured to obtain road network data at a current time point;

a road section classifying module, configured to classify the road network data based on road section types to obtain a road section set of each road section type, where the road section types include a congested road section, an uncongested road section susceptible to congestion, and an uncongested road section insusceptible to congestion;

a road network congestion predicting module, configured to predict a road network congestion situation at each time point within a predetermined time period based on the road section set of each road section type and the epidemic model to obtain road network prediction data, where the road network prediction data include a road section prediction set of each road section type at each time point;

a road network congestion propagation evaluation index obtaining module, configured to obtain road network congestion propagation evaluation indexes, including a propagation scale, propagation duration, and a propagation velocity; and

a road network congestion propagation situation analyzing module, configured to analyze the road network prediction data based on the road network congestion propagation evaluation indexes to obtain the road network congestion propagation situation at the current time point.

In an embodiment, the road section classifying module may include:

a relative velocity obtaining unit, configured to obtain a relative velocity on each road section at the current time point, where the relative velocity on the road section is a ratio of a real velocity on the road section to a quantile velocity on the road section, and the quantile velocity is a velocity at a predetermined quantile after velocities on the road section within the predetermined time period are sorted by magnitude;

a congestion determining unit, configured to determine whether the relative velocity is less than a congestion threshold;

a congested road section determining unit, configured to determine the road section corresponding to the relative velocity as the congested road section when the relative velocity is less than the congestion threshold;

an uncongested road section determining unit, configured to determine the road section corresponding to the relative velocity as the uncongested road section when the relative velocity is greater than or equal to the congestion threshold;

a congested road section proportion determining unit, configured to determine a congested road section proportion corresponding to each uncongested road section, where the congested road section proportion is a proportion of a number of congested road sections in all road sections connected to the uncongested road section;

a susceptible-to-congestion determining unit, configured to determine whether the congested road section proportion is greater than a proportion threshold;

a determining unit for the uncongested road section susceptible to congestion, configured to determine the uncongested road section corresponding to the congested road section proportion as the uncongested road section susceptible to congestion when the congested road section proportion is greater than the proportion threshold; and

a determining unit for the uncongested road section insusceptible to congestion, configured to determine the uncongested road section corresponding to the congested road section proportion as the uncongested road section insusceptible to congestion when the congested road section proportion is less than or equal to the proportion threshold.

In an embodiment, the system may further include:

an epidemic model determining module, configured to determine the epidemic model based on the road section set of each road section type before the road network congestion situation at each time point within the predetermined time period is predicted based on the road section set of each road section type and the epidemic model to obtain the road network prediction data, where the epidemic model includes an SIS model, an SIR model, an SIRS model, and an SEIR model;

a road network training data obtaining module, configured to obtain road network training data, where the road network training data are a road section set of each road section type at each time point within the predetermined time period;

a road network prediction data obtaining module, configured to input the road network training data into the epidemic model to obtain the road network prediction data, where the road network prediction data are a road section prediction set of each road section type at each time point within the predetermined time period;

a residual calculating module, configured to calculate a residual between the road network prediction data and the road network training data;

a residual determining module, configured to determine whether the residual is less than a residual threshold;

a model parameter updating module, configured to update parameters of the epidemic model by using weighted least-squares to fit model parameters when the residual is greater than or equal to the residual threshold, and return to the step of inputting the road network training data into the epidemic model to obtain the road network prediction data; and

a trained epidemic model determining module, configured to finish the training to obtain a trained epidemic model when the residual is less than the residual threshold.

In an embodiment, the road network congestion predicting module may include:

a probability obtaining unit, configured to obtain a first probability, a second probability, and a third probability at each time point within the predetermined time period, where the first probability is a probability that the uncongested road section susceptible to congestion becomes the congested road section, the second probability is a probability that the congested road section recovers to the uncongested road section, and the third probability is a probability that the recovered uncongested road section becomes the uncongested road section susceptible to congestion; and

a road network predicting unit, configured to predict the road network congestion situation at each time point by using formulas of

$$\frac{{dC}_{t}}{dt} = \frac{β {F}_{t} {C}_{t}}{N} - γ {C}_{t}$$

to obtain the road network

$$\frac{{dF}_{t}}{dt} = \frac{β {F}_{t} {C}_{t}}{N} + {ξR}_{t}$$

$$\frac{{dR}_{t}}{dt} = γ {C}_{t} - ξ {R}_{t}$$

prediction data; where Cₜ represents a scale of a set of congested road sections at a time point t, and

$$\frac{{dC}_{t}}{dt}$$

represents an amount of change in the scale Cₜ of the set of congested road sections at the time point t; Fₜ represents a scale of a set of uncongested road sections susceptible to congestion at the time point t, and

$$\frac{{dF}_{t}}{dt}$$

represents an amount of change in the scale Fₜ of the set of uncongested road sections susceptible to congestion at the time point t; Rₜ represents a scale of a set of uncongested road sections insusceptible to congestion at the time point t, and

$$\frac{{dR}_{t}}{dt}$$

represents an amount of change in the scale Rₜ of the set of uncongested road sections insusceptible to congestion at the time point t; and β represents the first probability, γ represents the second probability, and ξ represents the third probability.

In an embodiment, the road network congestion propagation situation analyzing module may include:

a congested road section set scale determining unit, configured to determine a scale of a set of congested road sections at each time point within the predetermined time period based on the road network prediction data;

a maximum congestion scale determining unit, configured to determine a maximum scale of the set of congested road sections within the predetermined time period, where a larger maximum scale of the set of congested road sections indicates a stronger road network congestion propagation capability;

a propagation inflection point duration determining unit, configured to determine propagation inflection point duration based on the scale of the set of congested road sections at each time point within the predetermined time period, where the propagation inflection point duration is duration from the current time point to a time point corresponding to the maximum scale of the set of congested road sections;

a propagation end duration determining unit, configured to determine propagation end duration based on the scale of the set of congested road sections at each time point within the predetermined time period, where the propagation end duration is duration from the current time point to a time point at which the scale of the set of congested road sections is zero; and

a road network congestion propagation velocity determining unit, configured to divide the maximum scale of the set of congested road sections by the propagation inflection point duration to obtain a road network congestion propagation velocity.

Based on specific embodiments provided in the present disclosure, the present disclosure has the following technical effects.

Globality: Existing traffic control methods often ignore congestion propagation over time and space. The methods cannot perform a comprehensive prediction based on historical data and real-time data. In addition, the methods focus only on a microscopic and local control without considering a inter-regional correlation, and lack algorithms and capabilities for spatio-temporal optimization. In contrast, the present disclosure considers a congestion propagation over time and space in an entire road network, and proposes the evaluation indexes of road network congestion propagation, including the propagation scale, the propagation duration, and the propagation velocity, so that a road network decision manager can globally, systematically, and integrally evaluate the road networks.

Real time: In conventional macro-level road network congestion evaluation indexes, the system MFD relationship is unstable and has a strong fluctuation in a control process, making it difficult to support real-time decisions on the road network management. Micro-level indexes are often based on simulation without mining the road network congestion propagation mechanism from actual data. In contrast, the congestion propagation model proposed in the present disclosure is established based on a real-time road network operation status, and thus can meet any time precision requirements of decision makers and evaluate the road network congestion situation in real time and dynamically.

Ease of study and judgment: In the present disclosure, the road network congestion propagation situation is predicted and evaluated. Specifically, the road network congestion propagation indexes are calculated based on a congestion scale curve simulated by the model, and periodic congestion propagation situations, such as a surge period, an inflection point, and an end period, are predicted. Therefore, an appropriate control timing may be selected and controls within key time periods can be prioritized to prevent or reduce a large-scale congestion propagation in the road networks.

Ease of popularization: The road network congestion propagation evaluation method proposed in the present disclosure can meet congestion propagation evaluation demands for different road networks, different time periods, different congestion levels, and different scenarios. The road network congestion propagation indexes proposed in the present disclosure are not limited by time and space, and can be used to evaluate the congestion propagation situation in any road network within any time period. Road network congestion propagation situations for different congestion levels can be evaluated by changing the congestion threshold. Road network congestion propagation situations under different internal and external disturbance conditions, such as road network congestion propagation situations within special time periods on a regular day, such as morning and evening peak hours, and road network congestion propagation situations under different disaster conditions, such as snow disasters, floods, and accidents, may be evaluated.

### BRIEF DESCRIPTION OF THE DRAWINGS

In order to explain the technical solutions in embodiments of the present disclosure or in the conventional art more clearly, the accompanying drawings required in the embodiments will be described below briefly. Apparently, the accompanying drawings in the following description show merely some embodiments of the present disclosure, and other drawings can be derived from these accompanying drawings by those of ordinary skill in the art without creative efforts.

FIG. 1 is a schematic flowchart of a method for predicting a road network congestion propagation situation based on an epidemic model according to the present disclosure; and

FIG. 2 is a schematic structural diagram of a system for predicting a road network congestion propagation situation based on an epidemic model according to the present disclosure.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by a person of ordinary skill in the art based on the embodiments of the present disclosure without creative efforts shall fall within the protection scope of the present disclosure.

To make the foregoing objectives, features, and advantages of the present disclosure clearer and more comprehensible, the present disclosure will be further described in detail below with reference to the accompanying drawings and specific embodiments.

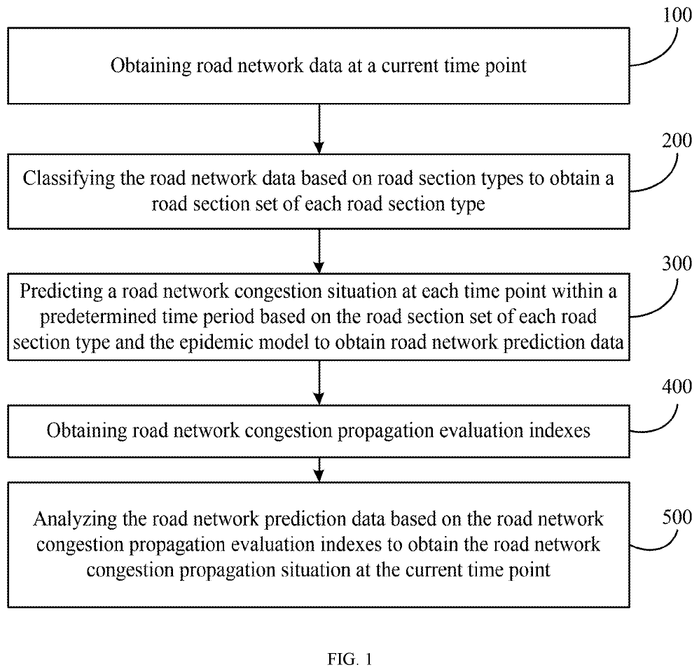

FIG. 1 is a schematic flowchart of a method for predicting a road network congestion propagation situation based on an epidemic model according to the present disclosure. As shown in FIG. 1, the method for predicting the road network congestion propagation situation based on the epidemic model in the present disclosure includes the following steps 100-500.

Step 100: road network data at a current time point are obtained. Specifically, a road network and a time period are selected, and velocities on all road sections in the road network at all time points within the time period are obtained. A velocity on road section i at a time point t is defined as vⁱ(t). A velocity on a road section is a traffic velocity of vehicles on the road section.

Step 200: the road network data are classified based on road section types to obtain a road section set of each road section type. The road section types include a congested road section, an uncongested road section susceptible to congestion, and an uncongested road section insusceptible to congestion. When a relative velocity on a road section at a time point is less than a predetermined threshold, the road section is regarded as the congested road section at the time point. When a relative velocity on a road section at a time point is greater than or equal to the predetermined threshold, the road section is regarded as the uncongested road section at the time point. When a proportion of congested road sections in all road sections connected to an uncongested road section at a time point is greater than a predetermined threshold, the uncongested road section is regarded as the uncongested road section susceptible to congestion at the time point. Otherwise, the uncongested road section is regarded as the uncongested road section insusceptible to congestion at the time point.

A specific process of classifying the road network data may be as follows:

A relative velocity on each road section at the current time point is obtained. The relative velocity on the road section is a ratio of a real velocity on the road section to a quantile velocity on the road section. The quantile velocity is a velocity at a predetermined quantile after velocities on the road section within the predetermined time period are sorted by magnitude. For example, velocities on the road section i within a time period T are sorted in ascending order, and a velocity at a 0.95-quantile is defined as v_{T}ⁱ. A velocity vⁱ(t) on the road section i at the time point t is divided by v_{T}ⁱ to obtain the relative velocity rⁱ(t) on the road section i at the time point t.

Whether the relative velocity is less than a congestion threshold q_{c} is determined.

When the relative velocity is less than the congestion threshold, it is determined that the road section corresponding to the relative velocity is the congested road section; or when the relative velocity is greater than or equal to the congestion threshold, it is determined that the road section corresponding to the relative velocity is the uncongested road section. The following formula is used:

$${e}_{c}^{i} ( t ) = \{ \begin{matrix}1 , & {r}^{i} ( t ) < {q}_{c} \\ 0 , & {r}^{i} ( t ) \geq {q}_{c}\end{matrix}$$

where e_{c}ⁱ(t) represents a status of the road section i at the time point t, a value of 1 indicates that the road section i is the congested road section at the time point t, and a value of 0 indicates that the road section i is the uncongested road section at the time point t; and q_{c} represents the predetermined congestion threshold, which ranges from 0 to 1.

A congested road section proportion corresponding to each uncongested road section is determined. The congested road section proportion is a proportion of the number of congested road sections in all road sections connected to the uncongested road section.

Whether the congested road section proportion is greater than a proportion threshold is determined.

When the congested road section proportion is greater than the proportion threshold, it is determined that the uncongested road section corresponding to the congested road section proportion is the uncongested road section susceptible to congestion; or when the congested road section proportion is less than or equal to the proportion threshold, it is determined that the uncongested road section corresponding to the congested road section proportion is the uncongested road section insusceptible to congestion. For example, the number of road sections connected to the uncongested road section j (e_{c}^{j}(t)=0) at the time point t is defined as n^{j}, and the number of congested road sections in the road sections connected to the road section j at the time point t is defined as

$${\sum }_{k = 1}^{{n}^{j}} {e}_{c}^{k} ( t ) \cdot {\sum }_{k = 1}^{{n}^{j}} {e}_{c}^{k} ( t )$$

is divided by n^{j} to obtain the congested road section proportion p_{c}^{j}(t) in the road sections connected to the road section j at the time point t. p_{c}^{j}(t) is compared with a predetermined susceptible-to-congestion determining threshold qₚ_{_{c}} to define the uncongested road sections susceptible to congestion in the road network. A variable that determines whether the road section j is susceptible to congestion at the time point t is defined as eₚ_{_{c}}^{j}(t). There is

$${e}_{{p}_{c}}^{j} ( t ) = \{ \begin{matrix}1 , & {p}_{c}^{j} ( t ) > {q}_{{p}_{c}} \\ 0 , & {p}_{c}^{j} ( t ) \leq {q}_{{p}_{c}}\end{matrix} .$$

where eₚ_{_{c}}^{j}(t) indicates whether the road section j is susceptible to congestion at the time point t, a value of 1 indicates that the road section j is susceptible to congestion at the time point t, and a value of 0 indicates that the road section j is insusceptible to congestion at the time point t; and qₚ_{_{c}} represents the predetermined susceptible-to-congestion determining threshold, which ranges from 0 to 1.

Step 300: a road network congestion situation at each time point within the predetermined time period is predicted based on the road section set of each road section type and the epidemic model to obtain road network prediction data. The road network prediction data include a road section prediction set of each road section type at each time point.

Before the road network congestion situation at each time point within the predetermined time period is predicted, the epidemic model needs to be established and trained. A specific process may be as follows.

The epidemic model is determined based on the road section set of each road section type and a road network congestion propagation process. An appropriate epidemic model is selected based on a scale of the road section set of each road section type to model the road network congestion propagation process. The epidemic model includes an SIS model, an SIR model, an SIRS model, and an SEIR model. When the congestion propagation dynamics is modeled, the following three processes need to be considered: the road section changes from an uncongested state to a congested state, the road section recovers from the congested state to the uncongested state, and the road section changes from the recovered uncongested state to the congested state. For example, the SIRS model in classic epidemic models may be used to establish a congestion propagation model. The SIRS model uses three differential equations to describe variations in the numbers of people of different types over time. In the embodiment, the three differential equations are used to describe variations in scales of sets of the three types of road sections, including a scale Cₜ of a set of the congested road sections, a scale Fₜ of a set of the uncongested road sections susceptible to congestion, and a scale Rₜ of a set of uncongested road sections insusceptible to congestion, at the time point t, respectively. The total number of road sections in the road network is defined as N. β represents a first probability, that is, a probability that the uncongested road section susceptible to congestion becomes the congested road section. γ represents a second probability, that is, a probability that the congested road section recovers to the uncongested road section. ξ represents a third probability, that is, a probability that the recovered uncongested road section becomes the uncongested road section susceptible to congestion. The SIRS model is as follows:

$$\begin{matrix}\frac{{dC}_{t}}{dt} = \frac{β {F}_{t} {C}_{t}}{N} - γ {C}_{t} \\ \frac{{dF}_{t}}{dt} = - \frac{β {F}_{t} {C}_{t}}{N} + ξ {R}_{t} . \\ \frac{{dR}_{t}}{dt} = γ {C}_{t} - ξ {R}_{t}\end{matrix}$$

where Cₜ represents the scale of the set of congested road sections at the time point t, and

$$\frac{{dC}_{t}}{dt}$$

represents an amount of change in the scale Cₜ of the set of congested road sections at the time point t; Fₜ represents the scale of the set of uncongested road sections susceptible to congestion at the time point t, and

$$\frac{{dF}_{t}}{dt}$$

represents an amount of change in the scale Fₜ of the set of uncongested road sections susceptible to congestion at the time point t; and Rₜ represents the scale of the set of uncongested road sections insusceptible to congestion at the time point t, and

$$\frac{{dR}_{t}}{dt}$$

represents an amount of change in the scale Rₜ of the set of uncongested road sections insusceptible to congestion at the time point t.

Road network training data are obtained. The road network training data are the road section set of each road section type at each time point within the predetermined time period T and defined as Cₜ^{real}(t=t₀, t₀+1, . . . , t₀+T).

Initial values of parameters of the epidemic model are set and the road network training data are input into the epidemic model to obtain the road network prediction data. The road network prediction data are the road section prediction set of each road section type at each time point within the predetermined time period T and defined as Cₜ^{simu}(t=t₀, t₀+1, . . . , t₀+T).

A residual between the road network prediction data and the road network training data are calculated. The residual is defined as

$${\sum }_{t = {t}_{0}}^{{t}_{0} + T} {{W}^{{t}_{0} + T - t} ( {C}_{t}^{real} - {C}_{t}^{simu} )}^{2} ,$$

where t₀ represents an initial time of parameter fitting; and W^{t}^{₀}^{+T-t} represents a weight of the residual at each time step.

Whether the residual is less than a residual threshold is determined.

When the residual is greater than or equal to the residual threshold, the parameters of the epidemic model are updated by using weighted least-squares to fit model parameters. The model parameters include weights. Then, the process returns to the step of inputting the road network training data into the epidemic model to obtain the road network prediction data to train the epidemic model.

When the residual is less than the residual threshold, the training is finished to obtain a trained epidemic model.

After the training is finished, the epidemic model may be used to predict the road network congestion situation at each time point within the predetermined time period. The process is as follows.

The first probability, the second probability, and the third probability at each time point within the predetermined time period are obtained. The first probability is the probability that the uncongested road section susceptible to congestion becomes the congested road section. The second probability is the probability that the congested road section recovers to the uncongested road section. The third probability is the probability that the recovered uncongested road section becomes the uncongested road section susceptible to congestion.

The road network congestion situation at each time point is predicted by using formulas of

$$\frac{{dC}_{t}}{dt} = \frac{β {F}_{t} {C}_{t}}{N} - γ {C}_{t}$$

to obtain the road network prediction data; where Cₜ represents the scale

$$\begin{matrix}\frac{{dF}_{t}}{dt} = - \frac{β {F}_{t} {C}_{t}}{N} + ξ {R}_{t} \\ \frac{{dR}_{t}}{dt} = γ {C}_{t} - ξ {R}_{t}\end{matrix}$$

of the set of congested road sections at the time point t, and

$$\frac{{dC}_{t}}{dt}$$

represents the amount of change in the scale Cₜ of the set of congested road sections at the time point t; Fₜ represents the scale of the set of uncongested road sections susceptible to congestion at the time point t, and

$$\frac{{dF}_{t}}{dt}$$

represents the amount of change in the scale Fₜ of the set of uncongested road sections susceptible to congestion at the time point t; Rₜ represents the scale of the set of uncongested road sections insusceptible to congestion at the time point t, and

$$\frac{{dR}_{t}}{dt}$$

represents the amount of change in the scale Rₜ of the set of uncongested road sections insusceptible to congestion at the time point t; and β represents the first probability, γ represents the second probability, and ξ represents the third probability.

Step 400: road network congestion propagation evaluation indexes are obtained. The road network congestion propagation evaluation indexes include a propagation scale, propagation duration, and a propagation velocity.

Step 500: the road network prediction data are analyzed based on the road network congestion propagation evaluation indexes to obtain a road network congestion propagation situation at the current time point. Step 500 may specifically include the following steps.

From a perspective of the propagation scale, a scale Cₜ of a set of congested road sections at each time point within the predetermined time period is determined based on the road network prediction data, and a maximum scale of the set of congested road sections within the predetermined time period is determined. The maximum scale of the set of congested road sections is regarded as a propagation scale index N_{C}. A larger value of N_{C} indicates a stronger road network congestion propagation capability.

From a perspective of the propagation duration, propagation inflection point duration t^{Inflection point} is determined based on the scale of the set of congested road sections at each time point within the predetermined time period. The propagation inflection point duration is duration from the current time point to a time point corresponding to the maximum scale of the set of congested road sections. Propagation end duration t^{End} is determined based on the scale of the set of congested road sections at each time point within the predetermined time period. The propagation end duration is duration from the current time point to a time point at which the scale of the set of congested road sections is zero. The propagation inflection point duration t^{Inflection point} and the propagation end duration t^{End} represent different stages of congestion propagation, and an appropriate control timing may be selected accordingly.

From a perspective of the propagation velocity, the maximum scale of the set of congested road sections is divided by the propagation inflection point duration t^{Inflection point} to obtain a road network congestion propagation velocity. Alternatively, the probability β that an uncongested road section susceptible to congestion becomes a congested road section after the uncongested road section susceptible to congestion is connected to the congested road section in the model may be used to represent the propagation velocity. A larger value of the parameter β indicates a stronger road network congestion propagation capability. In addition, the probability γ that a congested road section recovers to an uncongested road section in the model may be used to represent a road network congestion recovery velocity. The probability ξ that the recovered uncongested road section becomes the uncongested road section susceptible to congestion may be used to represent a possibility that road network congestion propagates again after recovery.

Based on the foregoing analysis, multi-factor evaluation methods, such as a fuzzy comprehensive evaluation method and an analytic hierarchy process, may be further used to evaluate road network congestion propagation situations under different conditions. Congestion propagation evaluation indexes are calculated for different time periods and road networks based on the foregoing road network congestion propagation evaluation indexes. The foregoing multi-factor evaluation methods are used to evaluate the congestion propagation situation in any road network within any time period.

Congestion propagation evaluation indexes may be calculated for different congestion thresholds based on the foregoing road network congestion propagation evaluation indexes. The foregoing multi-factor evaluation methods may be used to evaluate road network congestion propagation situations for different congestion levels, such as road network congestion propagation situations within special time periods on a regular day, such as morning and evening peak hours, and road network congestion propagation situations under different disaster conditions, such as snow disasters, floods, and accidents.

Based on the foregoing steps, the present disclosure addresses limitations of existing road network congestion analysis methods, such as insufficient research on a congestion propagation mechanism, excessive model parameters, a low generalization ability, a poor real-time performance, and a difficulty in supporting management decision-making. On the premise that the road network congestion propagation mechanism and road network manager's requirements for real-time decision-making are considered, the present disclosure establishes and solves a road network congestion propagation model based on the epidemic model, which represents a road network congestion propagation and dissipation mechanisms, and provides the method for predicting the road network congestion propagation situation. On this basis, an evaluation index system of the road network congestion propagation capability is proposed from the following three aspects: the propagation scale, the propagation duration, and the propagation velocity. Then road network congestion propagation situations under different conditions may be compared and evaluated in real time. The method can visually predict different stages of congestion propagation and a time point at which the inflection point occurs. Therefore, an appropriate control timing may be selected to prevent or reduce a large-scale road network congestion propagation.

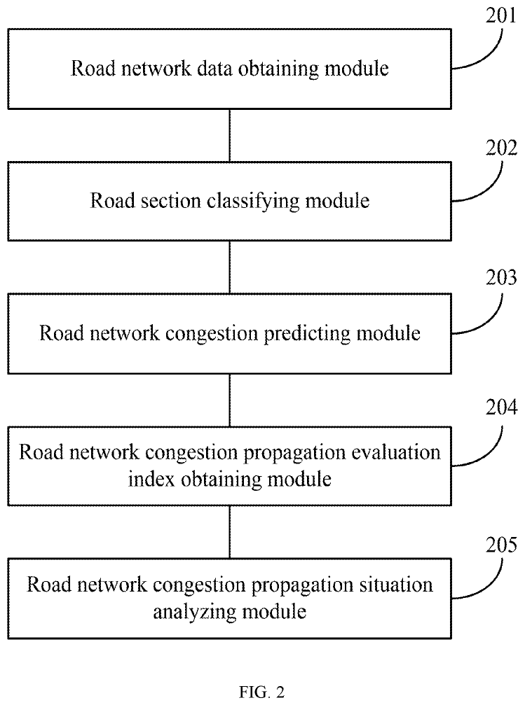

FIG. 2 is a schematic structural diagram of a system for predicting a road network congestion propagation situation based on an epidemic model according to the present disclosure. As shown in FIG. 2, the system for predicting the road network congestion propagation situation based on the epidemic model in the present disclosure includes the following modules 201-205.

A road network data obtaining module 201 is configured to obtain road network data at a current time point.

A road section classifying module 202 is configured to classify the road network data based on road section types to obtain a road section set of each road section type. The road section types include a congested road section, an uncongested road section susceptible to congestion, and an uncongested road section insusceptible to congestion.

A road network congestion predicting module 203 is configured to predict a road network congestion situation at each time point within a predetermined time period based on the road section set of each road section type and the epidemic model to obtain road network prediction data. The road network prediction data include a road section prediction set of each road section type at each time point.

A road network congestion propagation evaluation index obtaining module 204 is configured to obtain road network congestion propagation evaluation indexes. The road network congestion propagation evaluation indexes include a propagation scale, propagation duration, and a propagation velocity.

A road network congestion propagation situation analyzing module 205 is configured to analyze the road network prediction data based on the road network congestion propagation evaluation indexes to obtain the road network congestion propagation situation at the current time point.

In an embodiment, the road section classifying module 202 in the system for predicting the road network congestion propagation situation based on the epidemic model in the present disclosure may include the following units:

A relative velocity obtaining unit is configured to obtain a relative velocity on each road section at the current time point. The relative velocity on the road section is a ratio of a real velocity on the road section to a quantile velocity on the road section. The quantile velocity is a velocity at a predetermined quantile after velocities on the road section within the predetermined time period are sorted by magnitude.

A congestion determining unit is configured to determine whether the relative velocity is less than a congestion threshold.

A congested road section determining unit is configured to determine the road section corresponding to the relative velocity as the congested road section when the relative velocity is less than the congestion threshold.

An uncongested road section determining unit is configured to determine the road section corresponding to the relative velocity as the uncongested road section when the relative velocity is greater than or equal to the congestion threshold.

A congested road section proportion determining unit is configured to determine a congested road section proportion corresponding to each uncongested road section. The congested road section proportion is a proportion of the number of congested road sections in all road sections connected to the uncongested road section.

A susceptible-to-congestion determining unit is configured to determine whether the congested road section proportion is greater than a proportion threshold.

A determining unit for the uncongested road section susceptible to congestion is configured to determine the uncongested road section corresponding to the congested road section proportion as the uncongested road section susceptible to congestion when the congested road section proportion is greater than the proportion threshold.

A determining unit for the uncongested road section insusceptible to congestion is configured to determine the uncongested road section corresponding to the congested road section proportion as the uncongested road section insusceptible to congestion when the congested road section proportion is less than or equal to the proportion threshold.

In an embodiment, the system for predicting the road network congestion propagation situation based on the epidemic model in the present disclosure may further include the following modules:

An epidemic model determining module is configured to determine the epidemic model based on the road section set of each road section type before the road network congestion situation at each time point within the predetermined time period is predicted based on the road section set of each road section type and the epidemic model to obtain the road network prediction data. The epidemic model includes an SIS model, an SIR model, an SIRS model, and an SEIR model.

A road network training data obtaining module is configured to obtain road network training data. The road network training data are a road section set of each road section type at each time point within the predetermined time period.

A road network prediction data obtaining module is configured to input the road network training data into the epidemic model to obtain the road network prediction data. The road network prediction data are a road section prediction set of each road section type at each time point within the predetermined time period.

A residual calculating module is configured to calculate a residual between the road network prediction data and the road network training data.

A residual determining module is configured to determine whether the residual is less than a residual threshold.

A model parameter updating module is configured to update parameters of the epidemic model by using weighted least-squares to fit model parameters when the residual is greater than or equal to the residual threshold, and return to the step of inputting the road network training data into the epidemic model to obtain the road network prediction data.

A trained epidemic model determining module is configured to finish the training to obtain a trained epidemic model when the residual is less than the residual threshold.

In an embodiment, the road network congestion predicting module 203 in the system for predicting the road network congestion propagation situation based on the epidemic model in the present disclosure may include the following units:

A probability obtaining unit is configured to obtain a first probability, a second probability, and a third probability at each time point within the predetermined time period. The first probability is a probability that the uncongested road section susceptible to congestion becomes the congested road section. The second probability is a probability that the congested road section recovers to the uncongested road section. The third probability is a probability that the recovered uncongested road section becomes the uncongested road section susceptible to congestion.

A road network predicting unit is configured to predict the road network congestion situation at each time point by using formulas

$$\frac{d {C}_{t}}{d t} = \frac{β {F}_{t} {C}_{t}}{N} - γ {C}_{t}$$

to obtain the road network

$$\frac{d {F}_{t}}{d t} = - \frac{β {F}_{t} {C}_{t}}{N} + ξ {R}_{t} \\ \frac{d {R}_{t}}{d t} = γ {C}_{t} - ξ {R}_{t}$$

prediction data, where Cₜ represents a scale of a set of congested road sections at a time point t, and

$$\frac{d {C}_{t}}{d t}$$

represents an amount of change in the scale Cₜ of the set of congested road sections at the time point t; Fₜ represents a scale of a set of uncongested road sections susceptible to congestion at the time point t, and

$$\frac{d {F}_{t}}{d t}$$

represents an amount of change in the scale Fₜ of the set of uncongested road sections susceptible to congestion at the time point t; Rₜ represents a scale of a set of uncongested road sections insusceptible to congestion at the time point t, and

$$\frac{d {R}_{t}}{d t}$$

represents an amount of change in the scale Rₜ of the set of uncongested road sections insusceptible to congestion at the time point t; and β represents the first probability, γ represents the second probability, and ξ represents the third probability.

In an embodiment, the road network congestion propagation situation analyzing module 205 in the system for predicting the road network congestion propagation situation based on the epidemic model in the present disclosure may include the following units:

A congested road section set scale determining unit is configured to determine a scale of a set of congested road sections at each time point within the predetermined time period based on the road network prediction data.

A maximum congestion scale determining unit is configured to determine a maximum scale of the set of congested road sections within the predetermined time period. A larger maximum scale of the set of congested road sections indicates a stronger road network congestion propagation capability.

A propagation inflection point duration determining unit is configured to determine propagation inflection point duration based on the scale of the set of congested road sections at each time point within the predetermined time period. The propagation inflection point duration is duration from the current time point to a time point corresponding to the maximum scale of the set of congested road sections.

A propagation end duration determining unit is configured to determine propagation end duration based on the scale of the set of congested road sections at each time point within the predetermined time period. The propagation end duration is duration from the current time point to a time point at which the scale of the set of congested road sections is zero.

A road network congestion propagation velocity determining unit is configured to divide the maximum scale of the set of congested road sections by the propagation inflection point duration to obtain a road network congestion propagation velocity.

Each embodiment of this description is described in a progressive manner. Each embodiment focuses on the difference from other embodiments, and the same and similar parts between the embodiments may refer to each other. For the system disclosed in the embodiments, since the system corresponds to the method disclosed in the embodiments, the description is relatively simple, and reference may be made to the method description.

In this description, several specific embodiments are used for illustration of the principles and implementations of the present disclosure. The description of the foregoing embodiments is used to help illustrate the method and the core ideas of the present disclosure. In addition, persons of ordinary skill in the art can make various modifications in terms of specific implementations and the scope of application in accordance with the ideas of the present disclosure. In conclusion, the content of this description shall not be construed as a limitation to the present disclosure.

What is claimed is:

1. A method for predicting a road network congestion propagation situation based on an epidemic model, comprising:
obtaining road network data at a current time point;
classifying the road network data based on road section types to obtain a road section set of each road section type, wherein the road section types comprise a congested road section, an uncongested road section susceptible to congestion, and an uncongested road section insusceptible to congestion;
predicting a road network congestion situation at each time point within a predetermined time period based on the road section set of each road section type and the epidemic model to obtain road network prediction data, wherein the road network prediction data comprise a road section prediction set of each road section type at each time point;
obtaining road network congestion propagation evaluation indexes comprising a propagation scale, propagation duration, and a propagation velocity; and
analyzing the road network prediction data based on the road network congestion propagation evaluation indexes to obtain the road network congestion propagation situation at the current time point.

2. The method for predicting the road network congestion propagation situation based on the epidemic model according to claim 1, wherein the classifying the road network data based on road section types to obtain the road section set of each road section type comprises:
obtaining a relative velocity on each road section at the current time point, wherein the relative velocity on the road section is a ratio of a real velocity on the road section to a quantile velocity on the road section, and the quantile velocity is a velocity at a predetermined quantile after velocities on the road section within the predetermined time period are sorted by magnitude;
determining whether the relative velocity is less than a congestion threshold;
when the relative velocity is less than the congestion threshold, determining the road section corresponding to the relative velocity as the congested road section; or
when the relative velocity is greater than or equal to the congestion threshold, determining the road section corresponding to the relative velocity as the uncongested road section;
determining a congested road section proportion corresponding to each uncongested road section, wherein the congested road section proportion is a proportion of a number of congested road sections in all road sections connected to the uncongested road section;
determining whether the congested road section proportion is greater than a proportion threshold; and
when the congested road section proportion is greater than the proportion threshold, determining the uncongested road section corresponding to the congested road section proportion as the uncongested road section susceptible to congestion; or
when the congested road section proportion is less than or equal to the proportion threshold, determining the uncongested road section corresponding to the congested road section proportion as the uncongested road section insusceptible to congestion.

3. The method for predicting the road network congestion propagation situation based on the epidemic model according to claim 1, before the predicting the road network congestion situation at each time point within the predetermined time period based on the road section set of each road section type and the epidemic model to obtain road network prediction data, further comprising:
determining the epidemic model based on the road section set of each road section type, wherein the epidemic model comprises a susceptible-infectious-susceptible (SIS) model, a susceptible-infectious-recovered (SIR) model, a susceptible-infectious-recovered-susceptible (SIRS) model, and a susceptible-exposed-infectious-recovered (SEIR) model;
obtaining road network training data, wherein the road network training data are a road section set of each road section type at each time point within the predetermined time period;
inputting the road network training data into the epidemic model to obtain the road network prediction data, wherein the road network prediction data are a road section prediction set of each road section type at each time point within the predetermined time period;
calculating a residual between the road network prediction data and the road network training data;
determining whether the residual is less than a residual threshold; and
when the residual is greater than or equal to the residual threshold, updating parameters of the epidemic model by using weighted least-squares to fit model parameters, and returning to the step of inputting the road network training data into the epidemic model to obtain the road network prediction data; or
when the residual is less than the residual threshold, finishing the training to obtain a trained epidemic model.

4. The method for predicting the road network congestion propagation situation based on the epidemic model according to claim 1, wherein the predicting the road network congestion situation at each time point within the predetermined time period based on the road section set of each road section type and the epidemic model to obtain road network prediction data comprises:
obtaining a first probability, a second probability, and a third probability at each time point within the predetermined time period, wherein the first probability is a probability that the uncongested road section susceptible to congestion becomes the congested road section, the second probability is a probability that the congested road section recovers to the uncongested road section, and the third probability is a probability that the recovered uncongested road section becomes the uncongested road section susceptible to congestion; and
predicting the road network congestion situation at each time point by using formulas of
$$\frac{d {C}_{t}}{d t} = \frac{β {F}_{t} {C}_{t}}{N} - γ {C}_{t}$$
to obtain the road network prediction data; wherein Cₜ represents a scale
$$\frac{d {F}_{t}}{d t} = - \frac{β {F}_{t} {C}_{t}}{N} + ξ {R}_{t} \\ \frac{d {R}_{t}}{d t} = γ {C}_{t} - ξ {R}_{t}$$
of a set of congested road sections at a time point t, and
$$\frac{d {C}_{t}}{d t}$$
represents an amount of change in the scale Cₜ of the set of congested road sections at the time point t; Fₜ represents a scale of a set of uncongested road sections susceptible to congestion at the time point t, and represents
$$\frac{d {F}_{t}}{d t}$$
an amount of change in the scale Fₜ of the set of uncongested road sections susceptible to congestion at the time point t; Rₜ represents a scale of a set of uncongested road sections insusceptible to congestion at the time point t, and
$$\frac{d {R}_{t}}{d t}$$
represents an amount of change in the scale Rₜ of the set of uncongested road sections insusceptible to congestion at the time point t; and β represents the first probability, γ represents the second probability, and ξ represents the third probability.

5. The method for predicting the road network congestion propagation situation based on the epidemic model according to claim 1, wherein the analyzing the road network prediction data based on the road network congestion propagation evaluation indexes to obtain the road network congestion propagation situation at the current time point comprises:
determining a scale of a set of congested road sections at each time point within the predetermined time period based on the road network prediction data;
determining a maximum scale of the set of congested road sections within the predetermined time period, wherein a larger maximum scale of the set of congested road sections indicates a stronger road network congestion propagation capability;
determining propagation inflection point duration based on the scale of the set of congested road sections at each time point within the predetermined time period, wherein the propagation inflection point duration is duration from the current time point to a time point corresponding to the maximum scale of the set of congested road sections;
determining propagation end duration based on the scale of the set of congested road sections at each time point within the predetermined time period, wherein the propagation end duration is duration from the current time point to a time point at which the scale of the set of congested road sections is zero; and
dividing the maximum scale of the set of congested road sections by the propagation inflection point duration to obtain a road network congestion propagation velocity.

6. A system for predicting a road network congestion propagation situation based on an epidemic model, comprising:
a road network data obtaining module, configured to obtain road network data at a current time point;
a road section classifying module, configured to classify the road network data based on road section types to obtain a road section set of each road section type, wherein the road section types comprise a congested road section, an uncongested road section susceptible to congestion, and an uncongested road section insusceptible to congestion;
a road network congestion predicting module, configured to predict a road network congestion situation at each time point within a predetermined time period based on the road section set of each road section type and the epidemic model to obtain road network prediction data, wherein the road network prediction data comprise a road section prediction set of each road section type at each time point;
a road network congestion propagation evaluation index obtaining module, configured to obtain road network congestion propagation evaluation indexes comprising a propagation scale, propagation duration, and a propagation velocity; and
a road network congestion propagation situation analyzing module, configured to analyze the road network prediction data based on the road network congestion propagation evaluation indexes to obtain the road network congestion propagation situation at the current time point.

7. The system for predicting the road network congestion propagation situation based on the epidemic model according to claim 6, wherein the road section classifying module comprises:
a relative velocity obtaining unit, configured to obtain a relative velocity on each road section at the current time point, wherein the relative velocity on the road section is a ratio of a real velocity on the road section to a quantile velocity on the road section, and the quantile velocity is a velocity at a predetermined quantile after velocities on the road section within the predetermined time period are sorted by magnitude;
a congestion determining unit, configured to determine whether the relative velocity is less than a congestion threshold;
a congested road section determining unit, configured to determine the road section corresponding to the relative velocity as the congested road section when the relative velocity is less than the congestion threshold;
an uncongested road section determining unit, configured to determine the road section corresponding to the relative velocity as the uncongested road section when the relative velocity is greater than or equal to the congestion threshold;
a congested road section proportion determining unit, configured to determine a congested road section proportion corresponding to each uncongested road section, wherein the congested road section proportion is a proportion of a number of congested road sections in all road sections connected to the uncongested road section;
a susceptible-to-congestion determining unit, configured to determine whether the congested road section proportion is greater than a proportion threshold;
a determining unit for the uncongested road section susceptible to congestion, configured to determine the uncongested road section corresponding to the congested road section proportion as the uncongested road section susceptible to congestion when the congested road section proportion is greater than the proportion threshold; and
a determining unit for the uncongested road section insusceptible to congestion, configured to determine the uncongested road section corresponding to the congested road section proportion as the uncongested road section insusceptible to congestion when the congested road section proportion is less than or equal to the proportion threshold.

8. The system for predicting the road network congestion propagation situation based on the epidemic model according to claim 6, further comprising:
an epidemic model determining module, configured to determine the epidemic model based on the road section set of each road section type before the road network congestion situation at each time point within the predetermined time period is predicted based on the road section set of each road section type and the epidemic model to obtain the road network prediction data, wherein the epidemic model comprises an SIS model, an SIR model, an SIRS model, and an SEIR model;
a road network training data obtaining module, configured to obtain road network training data, wherein the road network training data are a road section set of each road section type at each time point within the predetermined time period;
a road network prediction data obtaining module, configured to input the road network training data into the epidemic model to obtain the road network prediction data, wherein the road network prediction data are a road section prediction set of each road section type at each time point within the predetermined time period;
a residual calculating module, configured to calculate a residual between the road network prediction data and the road network training data;
a residual determining module, configured to determine whether the residual is less than a residual threshold;
a model parameter updating module, configured to update parameters of the epidemic model by using weighted least-squares to fit model parameters when the residual is greater than or equal to the residual threshold, and return to the step of inputting the road network training data into the epidemic model to obtain the road network prediction data; and
a trained epidemic model determining module, configured to finish the training to obtain a trained epidemic model when the residual is less than the residual threshold.

9. The system for predicting the road network congestion propagation situation based on the epidemic model according to claim 6, wherein the road network congestion predicting module comprises:
a probability obtaining unit, configured to obtain a first probability, a second probability, and a third probability at each time point within the predetermined time period, wherein the first probability is a probability that the uncongested road section susceptible to congestion becomes the congested road section, the second probability is a probability that the congested road section recovers to the uncongested road section, and the third probability is a probability that the recovered uncongested road section becomes the uncongested road section susceptible to congestion; and
a road network predicting unit, configured to predict the road network congestion situation at each time point by using formulas of
$$\frac{d {C}_{t}}{d t} = \frac{β {F}_{t} {C}_{t}}{N} - γ {C}_{t}$$
to obtain the road network
$$\frac{d {F}_{t}}{d t} = - \frac{β {F}_{t} {C}_{t}}{N} + ξ {R}_{t} \\ \frac{d {R}_{t}}{d t} = γ {C}_{t} - ξ {R}_{t}$$
prediction data; wherein Cₜ represents a scale of a set of congested road sections at a time point t, and
$$\frac{d {C}_{t}}{d t}$$
represents an amount of change in the scale Cₜ of the set of congested road sections at the time point t; Fₜ represents a scale of a set of uncongested road sections susceptible to congestion at the time point t, and
$$\frac{d {F}_{t}}{d t}$$
represents an amount of change in the scale Fₜ of the set of uncongested road sections susceptible to congestion at the time point t; Rₜ represents a scale of a set of uncongested road sections insusceptible to congestion at the time point t, and
$$\frac{d {R}_{t}}{d t}$$
represents an amount of change in the scale Rₜ of the set of uncongested road sections insusceptible to congestion at the time point t; and β represents the first probability, γ represents the second probability, and ξ represents the third probability.

10. The system for predicting the road network congestion propagation situation based on the epidemic model according to claim 6, wherein the road network congestion propagation situation analyzing module comprises:
a congested road section set scale determining unit, configured to determine a scale of a set of congested road sections at each time point within the predetermined time period based on the road network prediction data;
a maximum congestion scale determining unit, configured to determine a maximum scale of the set of congested road sections within the predetermined time period, wherein a larger maximum scale of the set of congested road sections indicates a stronger road network congestion propagation capability;
a propagation inflection point duration determining unit, configured to determine propagation inflection point duration based on the scale of the set of congested road sections at each time point within the predetermined time period, wherein the propagation inflection point duration is duration from the current time point to a time point corresponding to the maximum scale of the set of congested road sections;
a propagation end duration determining unit, configured to determine propagation end duration based on the scale of the set of congested road sections at each time point within the predetermined time period, wherein the propagation end duration is duration from the current time point to a time point at which the scale of the set of congested road sections is zero; and
a road network congestion propagation velocity determining unit, configured to divide the maximum scale of the set of congested road sections by the propagation inflection point duration to obtain a road network congestion propagation velocity.
